(19) United States
(12) Patent Application Publication
(10) Pub. No.: US 2022/0287291 A1
(43) Pub. Date: Sep. 15, 2022

(54) CHEMICAL ROLLER

(71) Applicant: University of Tennessee Research Foundation, Knoxville, TN (US)

(72) Inventors: Matthew Edward Layne, Knoxville, TN (US); Parker Michael Alperin, Germantown, TN (US); Charles William Beasley, Signal Mountain, TN (US); Timothy S. Clements, Johnson City, TN (US); Corbin Matthew Day, Cleveland, TN (US); Tyler James Sheffield, Knoxville, TN (US)

(21) Appl. No.: 17/694,299

(22) Filed: Mar. 14, 2022

Related U.S. Application Data
(60) Provisional application No. 63/160,242, filed on Mar. 12, 2021.

(51) Int. Cl. A01M 21/04; B05D 1/28; B05C 1/08

(52) U.S. Cl. CPC A01M 21/043; B05D 1/28; B05C 1/0813; A01M 1/20

(57) ABSTRACT

The present subject matter relates to devices, systems, and methods for applying pesticides, herbicides, and other treatment chemicals to a surface. A roller application device for use in delivery of treatment chemicals to a landscape surface includes a handle assembly having a fluid connector configured to be connected to a treatment chemical source, and a roller applicator is connected to the handle assembly but configured to rotate about an axis. The handle assembly includes a fluid dispenser configured to deliver a treatment chemical from the treatment chemical source to the roller applicator, and the roller applicator is configured to absorb the treatment chemical in an outer surface of the roller applicator and transfer the treatment chemical to a surface upon contact with the surface.

### PRIORITY CLAIM

The present application claims the benefit of U.S. Patent Application Ser. No. 63/160,242, filed Mar. 12, 2021, the disclosure of which is incorporated herein by reference in its entirety.

### TECHNICAL FIELD

The subject matter disclosed herein relates generally to devices, systems, and methods for distributing chemical products. More particularly, the subject matter disclosed herein relates to devices, systems, and methods for applying pesticides to a surface.

### BACKGROUND

Pesticide sprayers are a staple in today's lawn care industry for distributing herbicides, insecticides, and other treatment chemicals. For example, these sprayers allow the user to quickly apply herbicide to areas in order to help prevent the growth and spread of weeds. A problem of spray drift arises, however, when spraying areas that are adjacent to flowers, sod, or any other plant that is not intended to be killed. Spray drift can cause the herbicide to contact plants that were not meant to be killed, which can result in a waste of time and money. When using pesticides between pavers that sit directly beside lawns, for example, over spray can be a major concern with killing grass or other foliage.

### SUMMARY

In accordance with this disclosure, devices, systems, and methods for applying pesticides to a surface are provided. In one aspect, a roller application device for use in delivery of treatment chemicals to a landscape surface is provided. In some embodiments, the device includes a handle assembly having a fluid connector configured to be connected to a treatment chemical source, and a roller applicator is connected to the handle assembly but configured to rotate about an axis. In some embodiments, the handle assembly includes a fluid dispenser configured to deliver a treatment chemical from the treatment chemical source to the roller applicator, and the roller applicator is configured to absorb the treatment chemical in an outer surface of the roller applicator and transfer the treatment chemical to a surface upon contact with the outer surface of the roller applicator.

In another aspect, a chemical delivery system is provided. The system includes a treatment chemical source, a handle assembly connected to the treatment chemical source, and a roller applicator connected to the handle assembly but configured to rotate about an axis. In some embodiments, the handle assembly includes a plurality of fluid conduits configured to deliver a treatment chemical from the treatment chemical source to the roller applicator, and the roller applicator is configured to absorb the treatment chemical in an outer surface of the roller applicator and transfer the treatment chemical to a surface upon contact with the outer surface of the roller applicator.

In another aspect, a method for delivering treatment chemicals to a surface, such as a landscape surface, is provided. In some embodiments, the method includes supplying a treatment chemical from a treatment chemical source to a roller applicator in fluid communication with the treatment chemical source, wherein the roller applicator is configured to rotate about an axis, absorbing the treatment chemical in an outer surface of the roller applicator, and transferring the treatment chemical to a surface upon contact with the outer surface of the roller applicator.

Although some of the aspects of the subject matter disclosed herein have been stated hereinabove, and which are achieved in whole or in part by the presently disclosed subject matter, other aspects will become evident as the description proceeds when taken in connection with the accompanying drawings as best described hereinbelow.

### BRIEF DESCRIPTION OF THE DRAWINGS

The features and advantages of the present subject matter will be more readily understood from the following detailed description which should be read in conjunction with the accompanying drawings that are given merely by way of explanatory and non-limiting example, and in which:

FIG. 1 is a perspective side view of a roller application device according to an embodiment of the presently disclosed subject matter.

FIG. 2 is a side view of a sealed locking collar system of a roller application device according to an embodiment of the presently disclosed subject matter.

FIG. 3 is a side cutaway view of a flow control valve of a roller application device according to an embodiment of the presently disclosed subject matter.

FIGS. 4 and 5 are a side view and a perspective side view, respectively, of a fluid dispenser of a roller application device according to embodiments of the presently disclosed subject matter.

FIG. 6 is a side view of an internal fluid dispenser configuration for a roller application device according to embodiments of the presently disclosed subject matter.

FIG. 7 is a side view of an external fluid dispenser configuration for a roller application device according to embodiments of the presently disclosed subject matter.

FIG. 8 is a side view of a direct contact fluid dispenser configuration for a roller application device according to embodiments of the presently disclosed subject matter.

FIG. 9 is a perspective view of a Smith 4-gallon sprayer, Smith Performance Sprayers, New York Mills, New York, United States of America, used in the Examples.

FIG. 10 is a photographic image showing roller application patterns and spray wand patterns as described in Example 2 herein below.

FIGS. 11A and 11B are photographic images prior to treatment application and seven (7) days after treatment application, respectively, as described in Example 3 herein below.

FIG. 12 is a photographic image illustrating the three rolls that the area covered as described in Example 6 herein below.

### DETAILED DESCRIPTION

The presently disclosed subject matter provides devices, systems, and methods for applying chemical pesticides, such as herbicides, insecticides, rodenticides, and/or other treatment chemicals, to a surface, such as a landscape surface or a commercial or residential wall or floor surface. In one aspect, to address problems with applying such treatment chemicals to areas that are in close proximity to necessary plants without the worry of contaminating them, the presently disclosed subject matter provides a tool to reduce and, in some embodiments, eliminate drip and overspray. In some embodiments, the presently disclosed subject matter provides a roller application device for use in delivery of treatment chemicals to the ground. In some embodiments, a roller is disclosed, wherein a treatment chemical is dispensed to the roller, and the roller is used to coat the surface, e.g., a landscape surface, with the treatment chemical. The presently disclosed roller can thus reduce and, in some embodiments, eliminate the fear of over spray and dripping pesticides on grass or other foliage. Similarly, when applying pesticides on or around commercial or residential buildings, it can be desirable to avoid spreading the pesticides to surrounding areas.

Following long-standing patent law convention, the terms “a”, “an”, and “the” refer to “one or more” when used in this application, including the claims. Thus, for example, reference to “a treatment chemical” includes a plurality of such treatment chemicals, and so forth.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

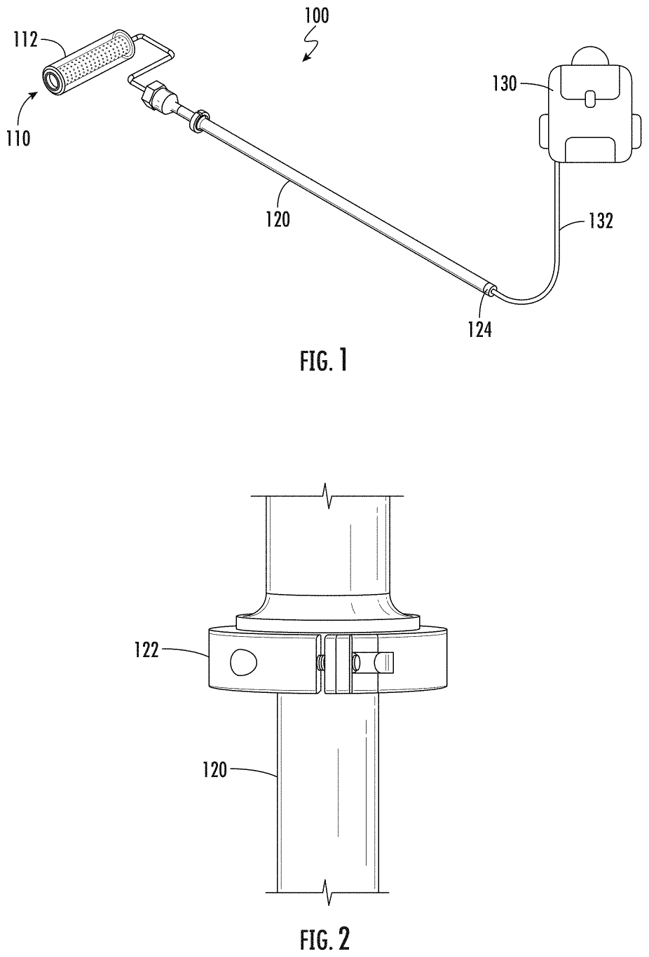

Referring to an example embodiment shown in FIG. 1, a roller application device, generally designated 100, can include a roller applicator 110 that is connected to a handle assembly 120. In some embodiments, the roller application device 100 is configured to dispense the treatment chemical to the roller applicator 110, which can absorb the treatment chemical onto an outer surface 112 of the roller applicator 110. In some embodiments, the roller applicator 110 comprises a medium density polyester presser roller cover.

However, any suitable roller cover can be employed, as would be apparent to one of ordinary skill in the art upon a review of the instant disclosure. In some embodiments, the roller applicator 110 can have any of a variety of lengths (e.g., between about 2 inches and 12 inches) designed for different applications. The treatment chemical can then be transferred onto the surface, such as a landscape surface, such as by rolling the roller applicator 110 across the surface. In this regard, the roller applicator 110 can be configured to rotate about an axis of the roller applicator 110. In some embodiments, the outer surface 112 of the roller applicator 110 is configured to be durable enough to withstand rolling contact with hard abrasive surfaces, including but not limited to concrete, stone, or other common landscape surfaces.

Again, any suitable material contributing to this feature can be employed, as would be apparent to one of ordinary skill in the art upon a review of the instant disclosure. In some embodiments, an aspect of the roller applicator 110 that is different from a normal paint roller is the use of a type of material of which the outer parts, such as a roller cover, of the roller are made. In some embodiments, the material, which can be a foam or other suitable material and can define the outer surface 112 of the roller applicator 110, is meant to be able to hold a liquid with a lower viscosity, such as a pesticide liquid mixture which is mostly water, as compared to a paint that has a much higher viscosity and therefore sticks to a traditional paint roller. In some embodiments, the material is a substantially fluid permeable material. As discussed above, in some embodiments, a suitable material for the outer surface 112 of the roller applicator 110 can be a medium density polyester foam (e.g., 100% open cell polyurethane foam). In some embodiments, the foam can be of any of a range of thicknesses (e.g., ranging from about 0.5 inches to about 2.0 inches, including thicknesses of about 0.5, 0.75, 1.0, 1.25, 1.5, 1.75, and 2.0 inches) that is designed to provide a desired volumetric carrying capacity of the treatment chemical. Alternatively, the material can be any of a variety of other materials that are configured to be substantially saturated with the treatment chemical before it is dispensed, including but not limited to other foam materials, woven or non-woven cloth materials (e.g., cotton, 50% cotton/50% polyester blend), or microfiber materials. Regardless of the particular composition, the material can be configured to be substantially saturated with the treatment chemical while preventing undesired dripping of liquid, and the material can also be configured to disperse the treatment chemical when placed against a surface.

In some embodiments, the handle assembly 120 can be configured to give the user a grip that is spaced apart from the roller applicator 110 and to provide leverage for the user to more easily press the roller applicator 110 against the landscape surface to dispense the treatment chemical. In some embodiments, the handle assembly 120 has a length (e.g., ranging from between about 32 in to 48 in) that is designed to allow the user to stand in a comfortable posture while applying the treatment chemical to a ground surface using the roller applicator 110 and/or to otherwise reach surfaces that are a distance away from the user. Alternatively or in addition, in some embodiments, the handle assembly 120 is selectively extendable to variable lengths so that the user can adjust the length of the handle assembly 120, such as to help the user to avoid excessive bending or reaching when applying the treatment chemical to a surface, such as a landscape surface. The handle assembly 120 can include a sealed locking collar system 122, such as is illustrated in FIG. 2. The seals within the collar system 122 are configured to be sufficiently tight to be able to hold a liquid with a lower viscosity, such as a pesticide liquid mixture which is mostly water, as compared to a paint that has a much higher viscosity.

In addition, in some embodiments, the handle assembly 120 is further configured to provide a supply channel for the treatment chemical from a treatment chemical source 130 to the roller applicator 110. The supply channel can be provided within a core of the handle assembly 120, or the supply channel can be a separate tube or other conduit, such as a fluid conduit 134 (see FIGS. 6-8), which is connected to the handle assembly 120. In some embodiments, the treatment chemical source 130 can be a backpack-mounted reservoir. In some embodiments, the handle assembly 120 of the roller application device 100 can be attached to a hose 132 of the treatment chemical source 130 by a fluid connector 124. In some embodiments, the hose 132 is connected to the fluid conduit 134. In such an arrangement, the roller application device 100 can be easily decoupled from the treatment chemical source 130, allowing the user to switch between different treatment chemical sources (e.g., different herbicides) or to switch to a conventional spray wand. For example, a user may attach a conventional spray wand to the treatment chemical source 130 to cover large areas of the landscape surface, but the spray want can be detached and swapped for the present roller application device 100 to finish a border area of the landscape surface around which spray drift would be more problematic.

In some embodiments, the treatment chemical source 130 is a pressurized vessel that is configured to push the treatment chemical throughout the roller application device 100 to the roller applicator 110. Such a configuration can be useful when applying the treatment chemical at a height of or above the treatment chemical source 130, such as when applying pesticides to walls and other surfaces of landscape structures or commercial or residential buildings. In some embodiments, a cutoff valve is provided at one or more of the treatment chemical source 130, the hose 132, and/or the handle assembly 120 to control the flow of the treatment chemical to the roller applicator 110. In some embodiments, roller application device 100 hooks into the treatment chemical source 130 right after the hand control cutoff valve of the treatment chemical source 130. This valve allows users start and stop the flow of liquid to the roller application device 100. Alternatively or in addition, in some embodiments, a flow control mechanism 140 is provided for regulating the flow of the treatment chemical to the roller applicator 110. In some embodiments, the flow control mechanism 140 allows flow through the handle assembly 120 and roller applicator 110 in a way that does not need to be actively controlled by the operator. In some embodiments, such a configuration relies on a balanced saturation of the roller applicator 110 and/or a spring-loaded flow valve, such as shown in FIG. 3. In some embodiments, the flow valve is configured to hold liquid back and only allow flow when the roller applicator 110 is pressed against a surface. In addition, in some embodiments, where the treatment chemical source 130 is positioned above the landscape surface (e.g., as a backpack-mounted reservoir), the supply of the treatment chemical to the roller applicator 110 can be gravity fed such that no positive pressure needs to be applied to cause the fluid to flow. As a further alternative, the flow control mechanism 140 can be a trigger valve installed at or in the handle assembly 120 that can be selectively activated to provide additional fluid flow on demand.

In any configuration, the flow control mechanism 140 can be configured to provide a flow of the treatment chemical to the roller applicator 110 at a desired rate to maintain a desired saturation of the outer surface 112 of the roller applicator 110 during application. In this way, as the treatment chemical is dispensed from the outer surface 112 to a surface by rolling the roller applicator 110 across the surface, the flow control mechanism 140 is configured to resupply the roller applicator 110 with the treatment chemical without requiring the user to delay. In some embodiments, to achieve such substantially continuous operation, the flow control mechanism 140 is configured to provide the treatment chemical to the roller applicator 110 at a rate ranging from about 0.10 fluid oz/sec to about 0.50 fluid oz/sec (e.g., including about 0.10, 0.15, 0.20, 0.25, 0.30, 0.33, 0.35, 0.40, 0.45, and 0.50 fluid oz/sec). Those having ordinary skill in the art will recognize however, that the flow control mechanism 140 can be configured to provide the treatment chemical to the roller applicator 110 at a different rate depending on the characteristics of the treatment chemical (e.g., viscosity), the width of the roller applicator 110, or other operating parameters of the roller application device 100.

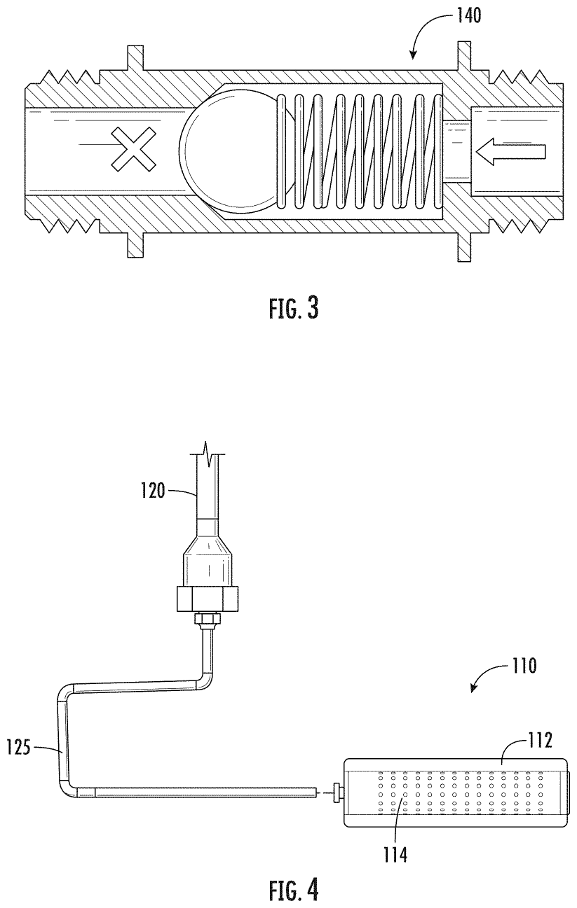

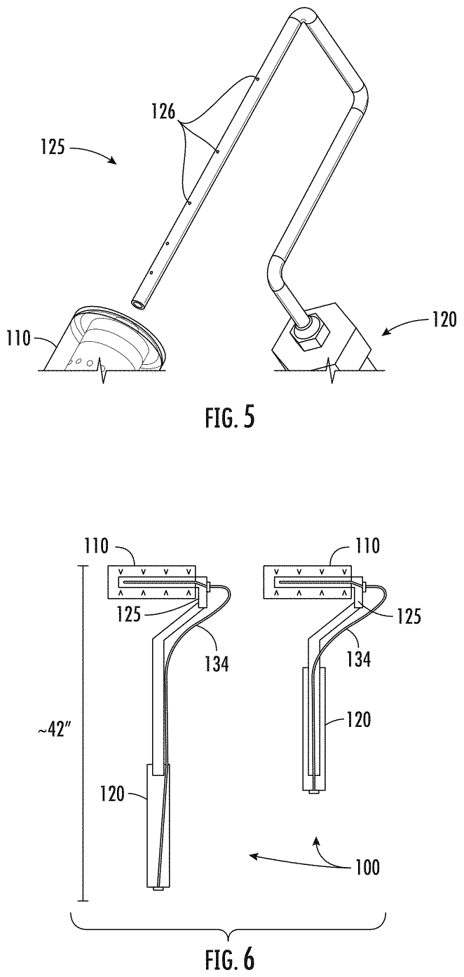

As shown in FIG. 4, in some embodiments, the treatment chemical can be fed to a fluid dispenser 125 that is connected to an end of the handle assembly 120 and to which the roller applicator 110 can be attached. In particular, the treatment chemical can be delivered through the fluid dispenser 125 to the roller applicator 110 through a plurality of fluid outlets 126 provided in an end of the fluid dispenser 125, such as is shown in FIG. 5. The fluid outlets 126 are sized, spaced, and otherwise configured to allow a suitable amount of flow through the roller application device 100 to provide a suitable amount of treatment chemical to the roller applicator 110, and are further configured to accommodate suitable flow rates for a range of different treatment chemicals.

In some embodiments, the roller application device 100 comprises an internal fluid dispenser, embodiments of which are illustrated in FIGS. 4, 5, and 6. In this arrangement, in some embodiments, the fluid dispenser 125 can be inserted into an interior chamber 114 of the roller applicator 110 such that the one or more fluid outlets 126 are arranged in communication with the internal chamber 114, and the roller applicator 110 can be configured to allow the treatment chemical to pass from the internal chamber 114 onto the outer surface 112 of the roller applicator 110. In some embodiments, the fluid outlets 126 are evenly spaced with the internal chamber 114 to disperse liquid evenly. The number, size, and/or shape of the fluid outlets 126 can be configured to provide a desired fluid flow from the fluid dispenser 125 to the roller applicator 110. In some embodiments, the configuration of the fluid outlets 126 can be designed in combination with the configuration of the flow control mechanism 140 to provide a flow of the treatment chemical to the roller applicator 110 at a rate that maintains a desired saturation of the outer surface 112 of the roller applicator 110 during application.

Further, in some embodiments, the internal chamber 114, which can be a hollow chamber, can be provided within the roller applicator 110. The internal chamber 114 allows treatment chemical to move around as the roller applicator 110 spins. In some embodiments, the chamber 114 has holes or slits that allow the treatment chemical to move into the material (which can comprise a foam or other material as described hereinabove) for the outer surface 112. The chamber 114 acts as a reservoir to keep the outer surface 112 constantly wet while in use. This arrangement allows the roller applicator 110 to work seamlessly without stopping to wait for the outer surface 112 of the roller applicator 110 to re-wet. In some embodiments, the number, size, and/or shape of the openings in the internal chamber 114 are configured to provide a desired fluid flow from within the internal chamber 114 to the roller applicator 110. In some embodiments, the configuration of these openings can be designed in combination with the configurations of the fluid outlets 126 and/or of the flow control mechanism 140 to provide a flow of the treatment chemical to the roller applicator 110 at a rate that maintains a desired saturation of the outer surface 112 of the roller applicator 110 during application.

As the roller applicator 110 is compressed against a surface to be treated, liquid held in a section of the outer surface 112 of roller applicator 110 is displaced onto the surface to be treated. Once the roller applicator 110 spins and the material in the section of outer surface 112 decompresses the liquid within the internal chamber 114 of roller applicator 110 will fill the outer surface 112 once more which new liquid from the internal chamber by capillary effect and suction.

Thus, in some embodiments and as discussed to some degree hereinabove, it can be beneficial for the roller applicator 110, or cover therefor, to be composed of a substantially fluid permeable material that can absorb the desired types of herbicides, insecticides, rodenticides, or other treatment chemicals to be used in a given application. By way of exemplification and not limitation, a suitable material is employed to provide a flow rate that is sufficiently high to keep the roller applicator 110 wet, and particularly the outer surface of the roller applicator 110 wet while in use, and also to provide a flow rate at a level that is not so high as to result in wasted treatment chemical. As discussed above, for example, in some embodiments, the treatment chemical can be supplied to the roller applicator 110 at a rate ranging from about 0.10 fluid oz/sec to about 0.50 fluid oz/sec (e.g., including about 0.10, 0.15, 0.20, 0.25, 0.30, 0.33, 0.35, 0.40, 0.45, and 0.50 fluid oz/sec). Additional discussion of flow rates in this regard are provided in the Examples herein below, e.g., a much lower product use rate as compared to a spray wand while still affording application control. In this way, the treatment chemical coats the roller applicator 110 from the inside out, allowing the user to keep the treatment chemical contained inside the roller applicator 110 until application. Also, due to the arrangement of the fluid dispenser 125 as being inserted into the interior chamber 114, this configuration of the roller applicator 110 creates an ease of access to change out the roller applicator 110. In some embodiments, the fluid dispenser 125 is connected to the fluid conduit 134.

In another embodiment, the roller application device 100 comprises an external fluid dispenser, embodiments of which are illustrated in FIG. 7. In some embodiments, the fluid dispenser 125 is connected to the fluid conduit 134. In such a configuration, the fluid dispenser 125 is positioned adjacent to but spaced apart from the outer surface 112 of the roller applicator 110 instead of within the interior chamber 114 of the roller applicator 110. In this arrangement, the treatment chemical can be dispensed onto the outer surface 112 of the roller applicator 110 to be applied to the landscape surface. In some embodiments, such an external dispenser can include one or more fluid outlets 126 provided in an end of the fluid dispenser 125 in a similar configuration to the configuration shown in FIG. 4 (e.g., the fluid outlets 126 are evenly spaced along the end of fluid dispenser 125), or the fluid dispenser 125 can include any of a variety of other spray nozzles or applicator tips that are configured to dispense the treatment chemical onto the outer surface 112 of the roller applicator 110. In such a configuration, the roller applicator 110 need not be formed of a substantially fluid permeable material but can be formed of such a material. In some embodiments, a cover comprising a substantially fluid permeable material as described elsewhere can be provided for roller applicator 110 so as to provide an outer surface 112 comprising a substantially fluid permeable material. The configuration still allows for the ease of access to change the roller applicator 110 as needed.

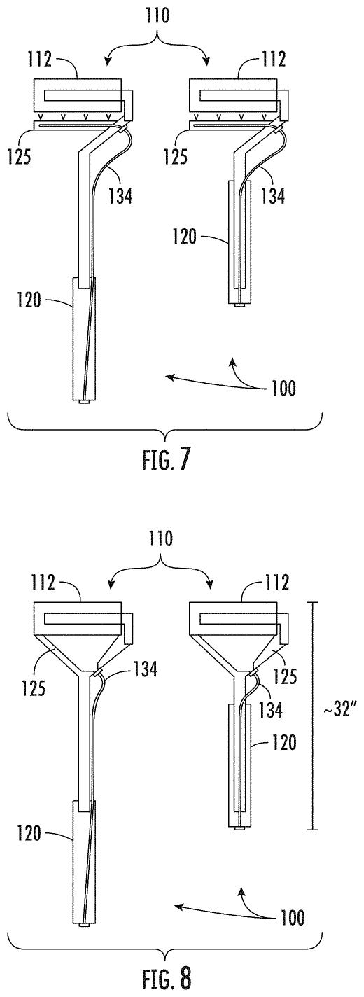

In another embodiment, the roller application device 100 comprises a direct contact fluid dispenser, embodiments of which are illustrated in FIG. 8. In some embodiments, the fluid dispenser 125 is connected to the fluid conduit 134. In this configuration, the fluid dispenser 125 comprises a reservoir type system that is positioned against the outer surface 112 of the roller applicator 110, and as the roller applicator 110 rolls, the fluid comes out and is evenly dispensed onto the outer surface 112 of the roller applicator 110. In this embodiment, the treatment chemical can be contained until it is dispensed onto the roller applicator 110. Thus, the roller applicator 110 again does not need to be formed of a substantially fluid permeable material to achieve a no drip/drift application but can be formed of such a material. In some embodiments, a cover comprising a substantially fluid permeable material as described elsewhere can be provided for roller applicator 110 so as to provide an outer surface 112 comprising a substantially fluid permeable material. There is a tradeoff in this embodiment, however, between the ability to directly coat the outer surface 112 of the roller applicator 110 and the ability to change the roller applicator 110 as needed. Due to positioning of the reservoir against the outer surface 112 of the roller applicator 110, changing the roller applicator 110 can be more complicated.

Regardless of the particular configuration of the roller application device 100, the application of a treatment chemical to a landscape surface can be achieved consistently without being impacted by changes in wind condition. As a result, operation of the roller application device 100 can result in greater on-target efficiency than conventional pesticide sprayers, and thus less product volume is needed.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

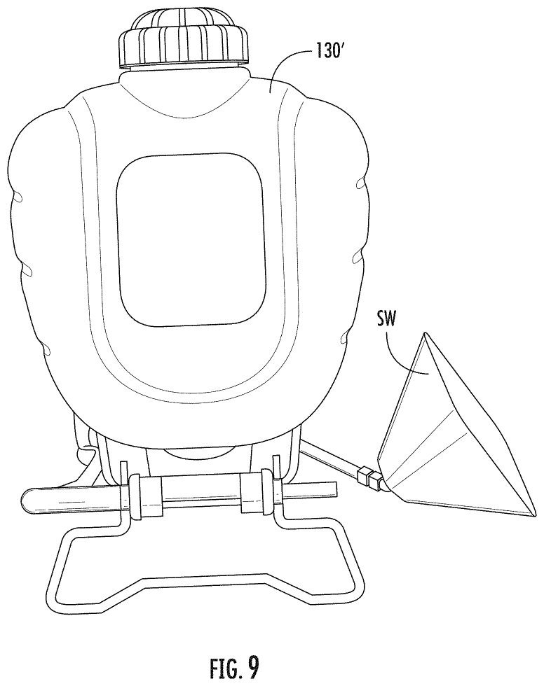

The device used in the following Examples corresponds to the device shown in FIG. 1, with roller applicator as shown in FIGS. 4 and 5, where the outer surface 112 of the roller applicator 110 comprises a 100% open cell polyurethane foam roller having a thickness of approximately 1.5 inches. The spray wand device used for comparison is a current industry standard device that is supposed to help prevent spray drift and is shown as SW in FIG. 9.

### Example 1: Comparison of Herbicide Application of Chemical Roller Application Device to Traditional Spray Wand Application

The experimental design was a one-way analysis of variance computed to compare the presently disclosed chemical roller application device to traditional spray wand applicators (P<0.05).

Experimental area: This research was performed at the East Tennessee Research and Education Center at the University of Tennessee, Knoxville, Tenn., United States of America. Example 1 took place over a concrete pad. Catch basins were used to collect and measure liquid application of both the presently disclosed chemical roller application device and traditional spray wand.

Treatments and Data collection: Treatments were applied using the same backpack sprayer (Smith 4-gallon sprayer, Smith Performance Sprayers, New York Mills, N.Y., United States of America; referred to as 130′ in FIG. 9) primed at the same rate with a wind speed of 0 mph as measured by a handheld anemometer (Kestrel 3000, Kestrel Instruments, Boothwyn, Pa., United States of America). The sprayer handle was used for both types of application, and only the wand attachment piece was changed for the roller application device. Each treatment was replicated three times, and the averages for each plot are reported. Each application had new catch basins for each data collection. The catch basins collected the liquid and was measured after each application. A goal of this Example was to determine the flow rate of the roller compared to the spray wand.

Data Collection Table

| | 1 Second | 3 Seconds | 10 Seconds |
|---|---|---|---|
| Roller | 0.33 oz | 1 oz | 3.3 oz |
| Spray Wand | 0.83 oz | 2.5 oz | 8.3 oz |

Summary: Results show that the presently disclosed chemical roller application device has a lower flow rate then the spray wand. During application, the spray wand must continually be primed (pumped); where, in this Example, the presently disclosed chemical roller application device is gravity fed and does not need continuous priming for application.

### Example 2: Impact Drift by Wind on the Efficiency and Accuracy of Roller Application

The experimental design was a one-way analysis of variance computed to determine if the effect of wind is significant on the presently disclosed chemical roller application device and spray wands (P<0.05).

Experimental area: This research was conducted at the East Tennessee Research and Education Center at the University of Tennessee. Example 2 was completed over a concrete pad. New catch basins were used to collect and measure liquid application of both the presently disclosed chemical roller application device and traditional spray wand.

Treatments and Data collection: A box fan (22YK19, Dayton Electric Mfg, Lake Forest, Ill., United States of America) and a handheld anemometer (Kestrel 3000, Kestrel Instruments, Boothwyn, Pa., United States of America) were used to set the different wind conditions. Wind conditions were established by moving distances away from the fan until the desired wind speed was established. The same backpack sprayer as described in Example 1 was used for all treatment applications, at each of the different wind speeds. For the distance of travel a six-inch-long area was treated and the distance from the end of the target application was measured. Each treatment was applied for three seconds with the backpack sprayer.

Data Collection Table

| | No Drift Chemical Herbicide Roller | | | Spray Wand | | |
|---|---|---|---|---|---|---|
| | | | Max distance | | | Max distance |
| Wind | Volume on | Volume | from | Volume | Volume | from |
| Speed | target | off target | application | on target | off target | application |
| 0 mph | 1.25 oz | 0 oz | 0 in | 2.5 oz | 0.1 oz | 3 in |
| 3 mph | 1.25 oz | 0 oz | 0 in | 2 oz | 1.5 oz | 13 in |
| 6 mph | 1.25 oz | 0 oz | 0 in | 1.5 oz | 1 oz | 18 in |
| 9 mph | 1.25 oz | 0 oz | 0 in | 1 oz | 1.5 oz | 23 in |

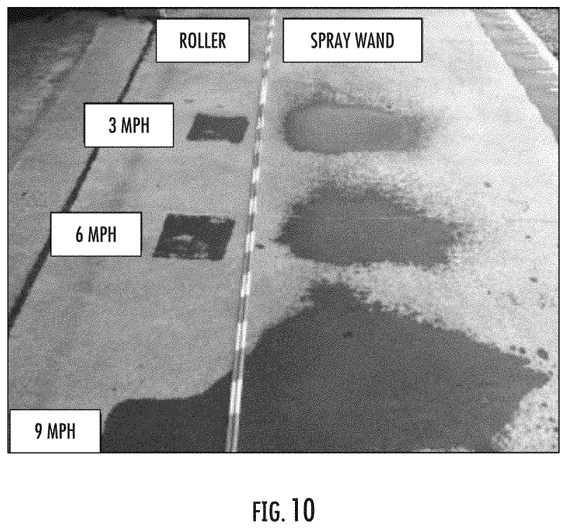

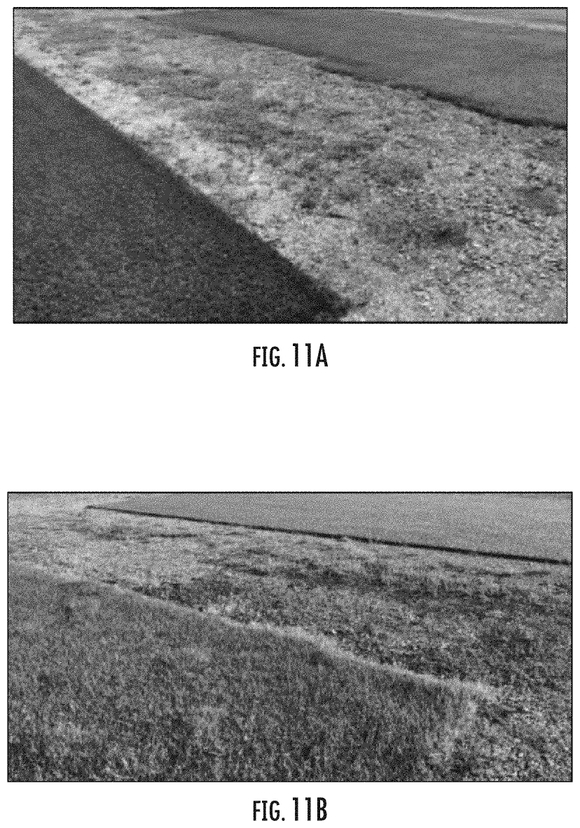

Summary: The presently disclosed chemical roller application device was not impacted by wind speeds up to 9 mph; where, product drifting did not occur. The spray wand was significantly impacted by changes in wind conditions. As wind speed increased distance from target and total off target volume (drifting) increased when using a spray wand. The use of the presently disclosed chemical roller application device used less product and had greater on target efficiency. See FIG. 10. It is of note that if the roller is oversaturated it can cause off target applications with the roller. This issue is readily addressed by care taken by the user. To elaborate, if the end user over pumps the chamber with liquid it will cause the outer surface of the roller applicator to become to full and drip.

### Example 3: Effectiveness of the Presently Disclosed Chemical Roller Application Device on Weed Control

The experimental design was setup as a one-way analysis of variance computed to determine the effectiveness of No Drift Chemical Herbicide Roller and spray wands on weed control (P<0.05).

Experimental area: The research was performed at the East Tennessee Research and Education Center at the University of Tennessee. Study 3 used a gravel base (path) infested with various grasses and broadleaf weeds. Individual testing areas comprised similar weeds, using a total of six 2 by 2 meter plots. See FIGS. 11A and 11B.

Data Collection Tables

| | |
|---|---|
| | Volume of product (water + |
| Time to apply | herbicide) Applied |

| | | | | |
|---|---|---|---|---|
| Roller | 25 | Seconds | 8.25 | oz |
| Spray wand | 15.7 | seconds | 18.06 | oz |

| | Amount of control 7 days | Amount of control 14 days |
|---|---|---|
| | after treatment | after treatment |
| Roller | 100% | 100% |
| Spray wand | 100% | 100% |

All plots with treatments applied with the spray wand or the presently disclosed chemical roller application device saw complete control seven days after application. These results indicate that the roller is just as effective at applying herbicides to control weeds as the spray wand in smaller areas. The spray wand applied the herbicide to a larger area faster but used two times more product over the same area.

Summary: The results of this study indicate that the use of the presently disclosed chemical roller application device is just as effective for applying herbicides in weed control as the spray wand. The presently disclosed chemical roller application device takes longer to apply. The reduction in water and herbicide volume used was attributed to the precision application of the presently disclosed chemical roller application device. This study indicates that the No Drift Chemical Herbicide Roller is effective at applying herbicides and reduces amount of product used due to its precision application.

### Additional Examples

Three additional examples were completed and discussed below to help answer the noted questions. These results are using a 9.75 inch wide roller with the set up as described in Example 1.

### Example 4—How Long Does it Take to Saturate the Roller from a Dry State?

The roller from a completely dry state had liquid applied until the roller was saturated. This was repeated three times. The average time it took for complete saturation to occur was 45 seconds or 14 fluid oz.

### Example 5—Once the Roller was Wet, What was the Recharge Time Between Emptying the Roller?

The wet roller (not saturated, having no or very small amounts of liquid coming out of the roller) was moved back and forth within a plastic box while the valve was opened, and water flowed into the roller. It took 5.5 seconds or 1.5 fluid oz on average to re-saturate the wet roller.

### Example 6—How Much Area Could a Fully Saturated Roller Cover?

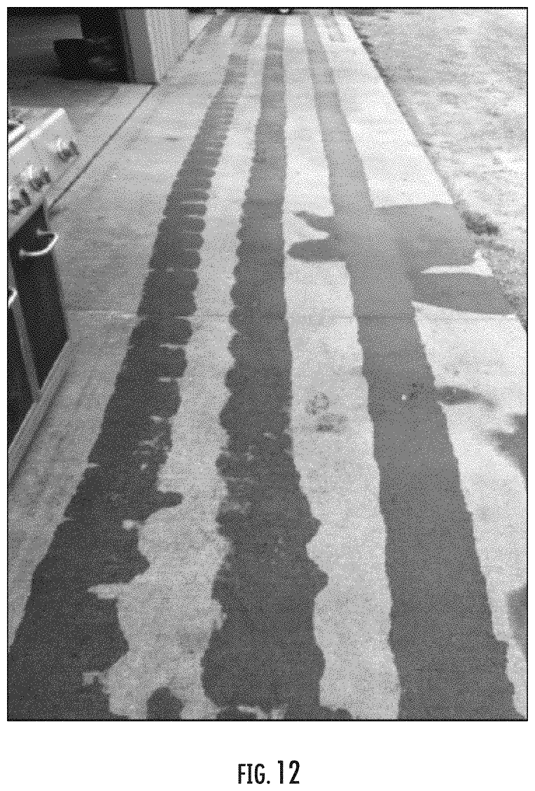

A small study replicated three times in this Example was completed with a fully saturated roller. This Example looked at the distance that the roller could cover before needing to be recharged. The results of this Example found that on average the roller could be applied to 52.5 feet in a row or 42.7 square feet. See FIG. 12. FIG. 12 is a photographic image illustrating the three rolls that the area covered.

### Overall Conclusions

The presently disclosed chemical roller application device is an effective tool to apply herbicides to spot treated weeds. It can take longer to treat a larger area then a spray wand; however, the primary purpose of the roller is to spot treat delivering precise applications in varying wind conditions. The presently disclosed chemical roller application device was not impacted by wind speeds up to 9 mph, this prevention of drift is an aspect of the presently disclosed chemical roller application device. Overall, the presently disclosed chemical roller application device is an effective tool to apply herbicides without the concern of drift.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

What is claimed is:

1. A roller application device for use in delivery of treatment chemicals to a surface, the device comprising:
a handle assembly comprising a fluid connector configured to be connected to a treatment chemical source; and
a roller applicator connected to the handle assembly but configured to rotate about an axis;
wherein the handle assembly comprises a fluid dispenser configured to deliver a treatment chemical from the treatment chemical source to the roller applicator; and
wherein the roller applicator is configured to absorb the treatment chemical in an outer surface of the roller applicator and transfer the treatment chemical to a surface upon contact with the surface.

2. The device of claim 1, wherein the handle assembly is selectively extendable to adjust a length of the handle assembly.

3. The device of claim 1, wherein the handle assembly comprises one or more fluid conduits connected between the fluid connector and the fluid dispenser.

4. The device of claim 3, wherein the one or more fluid conduits comprise a flow control mechanism configured to selectively regulate a flow of the treatment chemical to the roller applicator.

5. The device of claim 1, wherein the fluid dispenser comprises a plurality of fluid outlets in fluid communication with the outer surface of the roller applicator.

6. The device of claim 1, wherein the fluid dispenser is inserted into an interior chamber of the roller applicator, and
wherein the roller applicator is configured to pass the treatment chemical from the internal chamber to the outer surface of the roller applicator.

7. The device of claim 1, wherein the fluid dispenser is positioned adjacent to but spaced apart from the outer surface of the roller applicator, and
wherein the fluid dispenser is configured to dispense the treatment chemical directly to the outer surface of the roller applicator.

8. The device of claim 1, wherein the fluid dispenser comprises a fluid reservoir positioned in contact with the outer surface of the roller applicator, and
wherein the fluid dispenser is configured to dispense the treatment chemical directly to the outer surface of the roller applicator.

9. A chemical delivery system comprising:
a treatment chemical source;
a handle assembly connected to the treatment chemical source; and
a roller applicator connected to the handle assembly but configured to rotate about an axis;
wherein the handle assembly comprises a fluid dispenser configured to deliver a treatment chemical from the treatment chemical source to the roller applicator; and
wherein the roller applicator is configured to absorb the treatment chemical in an outer surface of the roller applicator and transfer the treatment chemical to a surface upon contact with the surface.

10. The system of claim 9, wherein the treatment chemical source comprises a backpack-mounted reservoir.

11. The system of claim 9, wherein the handle assembly is selectively extendable to adjust a length of the handle assembly.

12. The system of claim 9, wherein the handle assembly comprises one or more fluid conduits connected between the fluid connector and the fluid dispenser.

13. The system of claim 12, wherein the one or more fluid conduits comprise a flow control mechanism configured to selectively regulate a flow of the treatment chemical to the roller applicator.

14. The system of claim 9, wherein the fluid dispenser comprises a plurality of fluid outlets in fluid communication with the outer surface of the roller applicator.

15. The system of claim 9, wherein the fluid dispenser is inserted into an interior chamber of the roller applicator, and
wherein the roller applicator is configured to pass the treatment chemical from the internal chamber to the outer surface of the roller applicator.

16. The system of claim 9, wherein the fluid dispenser is positioned adjacent to but spaced apart from the outer surface of the roller applicator, and
wherein the fluid dispenser is configured to dispense the treatment chemical directly to the outer surface of the roller applicator.

17. The system of claim 9, wherein the fluid dispenser comprises a fluid reservoir positioned in contact with the outer surface of the roller applicator, and
wherein the fluid dispenser is configured to dispense the treatment chemical directly to the outer surface of the roller applicator.

18. A method for delivering treatment chemicals to a surface, the method comprising:
supplying a treatment chemical from a treatment chemical source to a roller applicator in fluid communication with the treatment chemical source, wherein the roller applicator is configured to rotate about an axis;
absorbing the treatment chemical in an outer surface of the roller applicator; and
transferring the treatment chemical to a surface upon contact with the outer surface of the roller applicator.

19. The method of claim 18, wherein supplying the treatment chemical from the treatment chemical source to the roller applicator comprises selectively regulating a flow of the treatment chemical to the roller applicator.

20. The method of claim 18, wherein supplying the treatment chemical from the treatment chemical source to the roller applicator comprises supplying the treatment chemical to a fluid dispenser configured to deliver a treatment chemical from the treatment chemical source to the roller applicator.

21. The method of claim 20, wherein the fluid dispenser is inserted into an interior chamber of the roller applicator, and
wherein supplying the treatment chemical from the treatment chemical source to the roller applicator comprises passing the treatment chemical from the internal chamber to the outer surface of the roller applicator.

22. The method of claim 20, wherein the fluid dispenser is positioned adjacent to but spaced apart from the outer surface of the roller applicator, and
wherein supplying the treatment chemical from the treatment chemical source to the roller applicator comprises dispensing the treatment chemical directly to the outer surface of the roller applicator.

23. The method of claim 20, wherein the fluid dispenser comprises a fluid reservoir positioned in contact with the outer surface of the roller applicator, and
wherein supplying the treatment chemical from the treatment chemical source to the roller applicator comprises dispensing the treatment chemical directly to the outer surface.

24. The method of claim 20, wherein the surface is a landscape surface.
